(19) United States
(12) Patent Application Publication
(10) Pub. No.: US 2005/0205410 A1
(43) Pub. Date: Sep. 22, 2005

(54) Capillary-in-ring electrode gas discharge generator for producing a weakly ionized gas and method for using the same

(75) Inventor: Sergei Babko-Malyi, Holland, PA (US)

Correspondence Address: DARBY & DARBY P.C., P. O. BOX 5257, NEW YORK, NY, 10150-5257, US

(73) Assignee: PlasmaSol Corporation, Hoboken, NJ (US)

(21) Appl. No.: 11/042,325

(22) Filed: Jan. 24, 2005

Related U.S. Application Data
(60) Provisional application No. 60/538,743, filed on Jan. 22, 2004.

(51) Int. Cl. B01J 19/08; B01J 19/12

(52) U.S. Cl. 204/164; 422/186.04

(57) ABSTRACT

A capillary-in-ring gas discharge generator including an inner dielectric having a capillary defined therein, a primary electrode having a distal end partially inserted axially into the capillary of the inner dielectric, an outer dielectric disposed about the inner dielectric and separated therefrom so as to define a discharge zone therebetween; and a secondary electrode extending radially outward of at least a portion of the outer dielectric proximate the distal end of the primary electrode. Weakly ionized gas emissions occur out from the capillary and also in a discharge region between the inner and outer dielectrics. Thus, a weakly ionized gas plume is produced having a size substantially equal to that of the inner opening of the outer dielectric which is able to efficiently treat a relatively large surface area.

### CROSS-REFERENCE TO RELATED APPLICATIONS

This application claims the benefit of U.S. Provisional Application No. 60/538,743, filed Jan. 22, 2004, which is hereby incorporated by reference. U.S. patent application Ser. No. 10/407,141, filed Apr. 2, 2003, which claims the benefit of U.S. Provisional Application No. 60/369,654, filed Apr. 2, 2002, are hereby incorporated by reference in their entirety.

### BACKGROUND OF THE INVENTION

1. Field of the Invention

The present invention is directed to a system and method for the generation of a weakly ionized gas (e.g., plasma), and, in particular, to a capillary-in-ring electrode configuration generator or reactor for producing a weakly ionized gas and method for using the same.

2. Description of Related Art

A “weakly ionized gas” is a partially ionized gas composed of ions, electrons, and neutral species. A “plasma” is but one example of a weakly ionized gas which is approximately electrically neutral (n+≈n−), that is, its positive charge is approximately equal to its negative charge. A weakly ionized gas is produced by relatively high temperatures or relatively strong electromagnetic fields either constant (DC) or time varying (e.g., RF or microwave). A weakly ionized gas can be produced by a gas discharge when free electrons are energized by electric fields in a background of neutral atoms/molecules. These electrons cause electron atom/molecule collisions which transfer energy to the atoms/molecules and form a variety of species which may include photons, metastables, atomic and molecular excited states, free radicals, molecular fragments, electrons and ions. The neutral gas becomes partially or fully ionized and is able to conduct electric currents. The species generated are chemically active and/or can physically modify the surface of materials and may therefore serve to form new chemical compounds and/or modify existing compounds. Electric gas discharges also produce useful amounts of electromagnetic radiation to be used for lighting. Numerous other uses for gas discharge devices are available.

U.S. Pat. Nos. 5,872,426; 6,005,349; and 6,147,452, each of which is herein incorporated by reference in their entirety, describe a glow discharge device for stabilizing a glow discharge mode by suppressing the transition from glow-to-arc. In this device a dielectric plate having an upper surface and a lower surface and a plurality of holes extending therethrough is positioned over an electrode plate and held in place by a collar. Each hole in the dielectric acts as a separate active current limiting micro-channel that prevents the overall current density from increasing above the threshold for the glow-to-arc transition. The use of capillaries in a dielectric while successful in limiting the current in order to suppress the glow-to-arc transition also limits the amount of plasma produced. To increase the amount of plasma produced the percentage of overall electrode area that the current limiting system occupies must be increased.

An alternative configuration of an ion generator for use in gas treatment is disclosed in U.S. Pat. No. 6,170,668. The generator comprises a dielectric tube surrounded by a grounded ring electrode disposed flush with the end of the dielectric tube. A wire electrode is positioned within the tube with a free end of the electrode being recessed from a free end of the tube. An electric field is generated by producing a difference in potential between the ring electrode and the wire electrode. The generator produces a plasma jet that is restricted in size to the inner diameter of the dielectric tube. Due to the relatively small size of the diameter of the dielectric tube, treatment of a surface subject to or exposed to the plasma jet is extremely time consuming. Another disadvantage of this patented design configuration is the glow-to-arc transition that occurs between the end of the wire electrode and the ring electrode at relatively low discharge power.

It is therefore desirable to develop a device that solves the aforementioned problems associated with conventional gas discharge generators while producing a relatively large volume of weakly ionized gas and minimizing arcing.

### SUMMARY OF THE INVENTION

The present invention is directed to an apparatus for generating weakly ionized gas preferably in the presence of an atmospheric pressure gas (e.g., air) using a coaxial configuration of electrodes and dielectrics with a central or inner electrode disposed within an open dielectric capillary and a receiving electrode with a dielectric barrier between the two electrodes.

A capillary-in-ring gas discharge generator in accordance with the present invention includes an inner dielectric having a capillary defined therein, a primary electrode having a distal end partially inserted axially into the capillary of the inner dielectric, an outer dielectric disposed about the inner dielectric and separated therefrom so as to define a discharge zone therebetween; and a secondary electrode extending radially outward of at least a portion of the outer dielectric proximate the distal end of the primary electrode. Discharge emissions occur out from the capillary and also in a discharge region between the inner and outer dielectrics. Thus, a weakly ionized gas plume is produced having a size substantially equal to that of the inner opening of the outer dielectric which is able to efficiently treat a relatively large surface area.

The present invention is also related to a method for using the capillary-in-ring gas discharge generator, as described above, by applying a voltage differential between the primary and secondary electrodes and generating a weakly ionized gas.

### BRIEF DESCRIPTION OF THE DRAWING

The foregoing and other features of the present invention will be more readily apparent from the following detailed description and drawings of illustrative embodiments of the invention wherein like reference numbers refer to similar elements throughout the several views and in which:

FIG. 1 is a longitudinal cross-sectional view of an exemplary capillary-in-ring configuration non-thermal annular gas discharge reactor for producing a weakly ionized gas in accordance with the present invention; and

FIG. 2 is a partial cross-sectional view of another exemplary capillary-in-ring configuration gas discharge reactor and supporting screw.

### DETAILED DESCRIPTION OF THE INVENTION

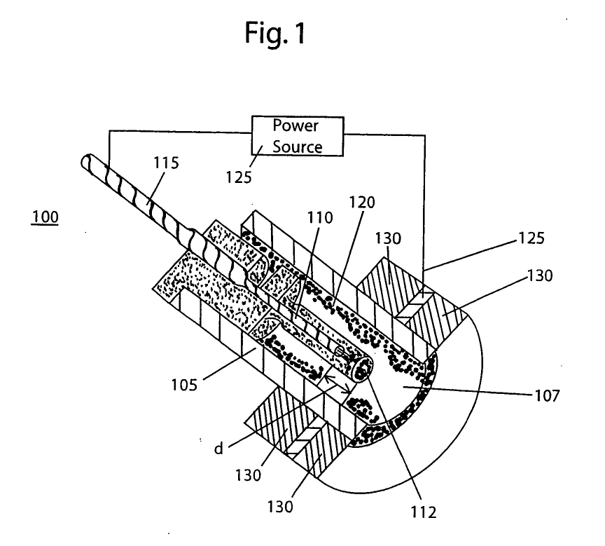

FIG. 1 is a longitudinal cross-sectional view of an exemplary capillary-in-ring configuration gas discharge generator 100 for producing a weakly ionized gas in accordance with the present invention. Generator 100 includes an outer dielectric 105 (e.g., quartz) having a hollow passageway 107 in which is disposed an inner dielectric 110 that also has an opening defined longitudinally therethrough to form a capillary 112. Inner dielectric 110 is separated from the outer dielectric 105 by a predetermined distance, preferably approximately 3mm. In the preferred embodiment shown in FIG. 1, the inner dielectric 110 is disposed substantially concentrically with the outer dielectric 105. Inserted at least partially in the capillary 112 of the inner dielectric 110 is a primary or first electrode 115 such as a metal wire (e.g., nickel or platinum). A wire, rod, or cylindrical shaped electrode may be readily and inexpensively manufactured but any other shaped electrode may be substituted. The wire preferably is inserted into the capillary 112 so as to maintain a distance “d” greater than zero, preferably approximately 2 mm, between the terminating end of the primary electrode 115 and the terminating end of the inner dielectric 110 disposed inside the hollow passageway 107 of the outer dielectric 105. It is advantageous to maintain some distance between the terminating end of the primary electrode and the terminating end of the inner dielectric so that the terminating end portion of the capillary 112 in which the electrode 115 is absent acts as a choke suppressing transition of a discharge into the arc mode. If a reagent gas is introduced into the capillary it may serve as a shield gas to reduce erosion of the electrode 115. Assuming that a reagent gas is introduced into the capillary, weakly ionized gas will be generated in the reagent gas prior to being emitted out from the capillary and into a main gas stream.

Alternatively, the design may be modified so that either: (i) the terminating end of the primary electrode 115 and terminating end of the inner dielectric 110 are substantially flush with one another; or (ii) the terminating end of the primary electrode 115 extends beyond the terminating end of the inner dielectric 110. However, in either of these alternative configurations transition of the discharge to arc mode will undesirably occur at relatively low discharge power. Shielding of the electrode by introduction of a reagent gas through the capillary will be less effective in these two alternative configurations. Lastly, if a reagent gas is introduced into the capillary, the plasma will be generated in the mixture of the main gas and reagent gas.

A secondary electrode 125 (e.g., a metallic foil or layer made, for example, of nickel or copper) depicted in FIG. 1 as being in the shape of a disk or ring is disposed about at least a portion of the outer perimeter of the outer dielectric 105. The preferred shape of the secondary electrode is that or a disk or ring but may be modified, as desired. In addition, secondary electrode 125 is preferably disposed substantially concentric with the primary electrode 115. The receiving or secondary electrode 125 is disposed radially outward proximate the terminating end of the primary electrode 115, preferably in a plane substantially perpendicular to a longitudinal axis of the primary electrode. A barrier dielectric 130 (e.g., ring, washer or disk shaped) is disposed about at least a portion of the outer perimeter of the outer dielectric 105 proximate its terminating end so as to prevent or substantially reduce the passage or production of weakly ionized gas between the open terminating end of the outer dielectric 105 and the secondary electrode 125. Additional dielectric material 130′ may be employed on the other side of the receiving secondary electrode 125 opposite that of the barrier dielectric 130 to prevent oxidation while providing protection to an otherwise exposed surface of the secondary electrode 125. The barrier dielectric and additional dielectric may be the same material. It is to be noted, however, that this additional dielectric 130′ may be omitted in practicing the present invention.

A power source 135 is connected to the primary and secondary electrodes 1 15, 125, respectively, and a voltage differential applied therebetween to produce a weakly ionized gas (as represented by the small arrows) in a discharge zone or region 120 defined as the space between the outer and inner dielectrics 105, 110, respectively. An object (e.g., a gas, vapor, liquid or solid) subject to exposure or treatment by the weakly ionized gas may be placed proximate or in contact with the open distal end of the weakly ionized gas discharge reactor 100 from which the weakly ionized gas is emitted. Rather than producing a weakly ionized gas jet (as in the prior art) that is limited in size to that of the inner diameter of the capillary 112 of the inner dielectric 110, the generator in accordance with the present invention produces a weakly ionized gas plume larger in size than the jet and thus able to cover a greater surface area to be treated more efficiently. Specifically, the weakly ionized gas plume emitted from the open end of the generator 100 has a size approximately equal to that of the inner opening or passageway of the outer dielectric 105, i.e., the diameter of the hollow passageway 107.

In addition, or alternatively, the object to be treated, typically a gas, may be introduced into the capillary 112 where it is exposed to the maximum concentration of weakly ionized gas produced in the discharge zone 120. An organic based reagent, for example, ethylene, may be introduced into the capillary 112 to improve the stability and/or optimize chemical reactions in the weakly ionized gas.

If the primary electrode 115 terminates in a pointed tip, a higher electric field will be produced requiring a lower breakdown voltage. The field is non homogenous having properties like a corona with a proportionate decline in field strength as the radius increases. For illustration purposes the reactor shown in FIG. 1 is annular or cylindrical in shape, however, any other shape is contemplated and within the intended scope of the invention.

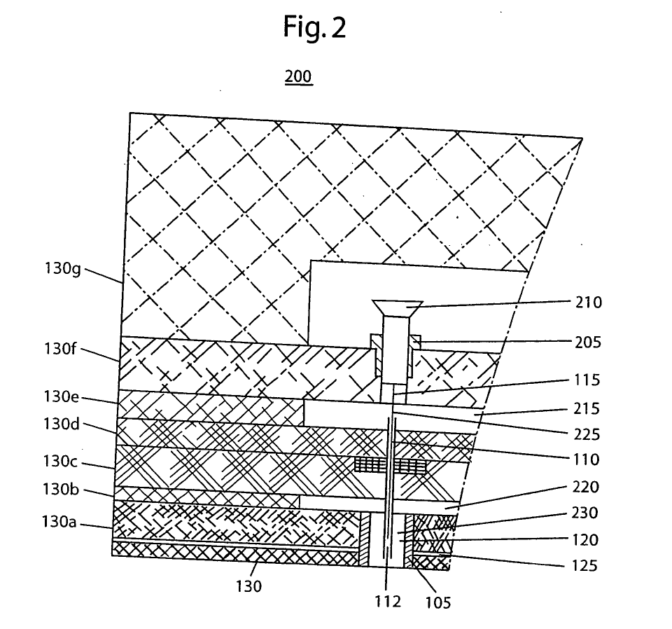

FIG. 2 is a partial cross-sectional view of a weakly ionized gas discharge reactor 200 depicting a single capillary-in-ring structure and associated supporting screw. The lower portion of the apparatus shown in FIG. 2 is similar to that of FIG. 1 in that it includes an inner dielectric 110 having a primary electrode 115 (e.g., a metal wire) inserted partially therein. An outer dielectric 105 (e.g., dielectric sleeve) is received in a complementary sized hole defined in dielectric layer 130a. The secondary electrode 125 is preferably a metallic foil layer disposed radially outward from the outer dielectric 105 proximate the terminating end of the inner dielectric 110. A plurality of dielectric layers 130a-130g are employed. The number of dielectric layers employed may be varied, as desired. Furthermore, the dielectric layers 130a-130g may be made from the same or different materials. Factors in selecting the number of dielectric layers may include the desire to incorporate a cooling chamber to provide cooling of the reactor. The choice in material may also be based on such properties as dielectric strength, coefficient of expansion, and percent of heat transfer.

In contrast to the embodiment shown in FIG. 1 wherein the inlet to the hollow passageway 107 of the outer dielectric 105 is blocked to prevent the introduction of a reagent or shield gas therein, the alternative embodiment in FIG. 2 has two inlets for receiving reagent gas. Specifically, a first channel 215 is preferably provided in the dielectric 130e proximate the opening of the capillary 112 to permit the introduction of a first reagent or shield gas 225 therein to improve the stability or optimize chemical reactions in the plasma. In the second embodiment, a second channel 220 may also be provided in one of the dielectric layers, e.g., dielectric layer 130b, so as to be in fluid communication with the discharge zone 120 defined between the outer and inner dielectrics 105, 110, respectively. A second reagent or shield gas 230 may be introduced through the second channel 220 into the discharge zone 120 to further improve the stability or optimize chemical reactions in the plasma. The invention contemplates employing the first reagent gas introduced into the first channel and/or the second reagent gas received in the second channel. By way of example, the first and second reagent or shield gasses 225, 230, respectively, may be the same or different, wherein the reagent gas, for example, may be ethylene.

Primary electrode 115 is displaceable axially within the capillary 112 so as to adjust its depth of insertion therein, as desired. By way of example, FIG. 2 shows the proximal end of the primary electrode 115 attached to a screw 210 able to be threaded within a receiving sleeve 205, wherein the screw and sleeve have complementary outer and inner threads. Any other mechanical and/or electrical device for adjusting the depth of the primary electrode 115 axially within the associated capillary 112 may be used.

Although the gas discharge generator shown in FIG. 2 is designed with only a single capillary-in-ring structure, the reactor may be modified, as desired, to include any number of one or more capillary-in-ring structures. When the reactor has multiple capillary-in-ring structures, preferably a mechanical and/or electrical displacement device such as the screw shown in FIG. 2 is provided for independently adjusting the insertion or depth of each primary electrode substantially axially or longitudinally within its associated capillary.

The capillary-in-ring gas discharge generator in accordance with the present invention produces a weakly ionized gas, e.g., a plasma, suitable for a variety of uses and applications. Plasma is of particular interest in the area of sterilization of objects or surfaces, wherein exposure to the plasma reduces the number of microorganisms living on the object or surface without the use of toxic chemical sterilant. For instance, the capillary-in-ring gas discharge generator may be used as the sterilization means in a sterilizer, for example, for medical objects. Other processes such as disinfection or decontamination may require a lower level of destruction of microorganisms living on the object or surface. Different levels of destruction of microorganisms living on the object or surface may be realized by altering the conditions (e.g., injecting an organic based reagent into the weakly ionized gas or varying the period of exposure to the plasma) associated with the gas discharge generator.

Aside from objects or surfaces, the gas discharge generator may be used to purify unwanted elements or compounds from gases (e.g., the air). Discharge plasma can also produce useful amounts of optical radiation to be used for lighting. Numerous other uses for the gas discharge generator are available and within the intended scope of the present invention.

All references, publications, pending and issued patents are herein each incorporated by reference in their entirety.

Thus, while there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps which perform substantially the same function, in substantially the same way, to achieve the same results are within the scope of the invention. Substitutions of elements from one described embodiment to another are also fully intended and contemplated. It is also to be understood that the drawings are not necessarily drawn to scale, but that they are merely conceptual in nature. It is the intention, therefore, to be limited only as indicated by the scope of the claims appended hereto.

1. A capillary-in-ring gas discharge generator for producing a weakly ionized gas, comprising:
an inner dielectric having a capillary defined therein;
a primary electrode having a distal end partially inserted axially into the capillary of the inner dielectric;
an outer dielectric disposed about the inner dielectric and separated therefrom so as to define a discharge zone therebetween; and
a secondary electrode extending radially outward of at least a portion of the outer dielectric proximate the distal end of the primary electrode.

2. The generator in accordance with claim 1, wherein the inner and outer dielectrics are substantially concentric.

3. The generator in accordance with claim 2, wherein the inner and outer dielectrics are cylindrical tubes.

4. The generator in accordance with claim 1, wherein the generator produces a weakly ionized gas plume substantially equal in size to an inner opening of the outer dielectric.

5. The generator in accordance with claim 1, wherein the inner dielectric is adapted to permit the passage of a reagent gas through the capillary.

6. The generator in accordance with claim 1, wherein the outer dielectric is adapted to permit the passage of a reagent gas through the discharge zone.

7. The generator in accordance with claim 1, wherein the secondary electrode is at least partially enclosed in a barrier dielectric to suppress arcing between the outer dielectric and the secondary electrode.

8. The generator in accordance with claim 1, wherein the secondary electrode is in the shape of a ring or disk.

9. The generator in accordance with claim 1, wherein the primary electrode is adapted to be varied as to its depth of insertion axially in the inner dielectric.

10. The generator in accordance with claim 19, wherein the primary electrode is partially inserted axially into the inner dielectric so that the distal end of the primary electrode received in the inner dielectric and recessed by a predetermined distance from its distal end.

11. The generator in accordance with claim 10, wherein the predetermined distance separation between the distal end of the primary electrode and the distal end of the inner dielectric is approximately 2 mm.

12. The generator in accordance with claim 1, wherein the secondary electrode lies in a plane that is disposed substantially perpendicular to a longitudinal axis of the primary electrode.

13. A capillary-in-ring gas discharge generator for producing a weakly ionized gas, comprising:
a first dielectric having a capillary defined therein;
a primary electrode inserted axially partially into the capillary of the first dielectric;
a second dielectric disposed about the first dielectric and separated therefrom so as to define a discharge zone therebetween; and
a secondary electrode disposed substantially transverse to the primary electrode and extending radially about at least a portion of the secondary dielectric.

14. A method for generation of a weakly ionized gas using a capillary-in-ring gas discharge generator that includes an inner dielectric having a capillary defined therein; a primary electrode partially inserted axially into the capillary of the inner dielectric; an outer dielectric disposed about the inner dielectric and separated therefrom so as to define a discharge zone therebetween; a secondary electrode extending radially outward of at least a portion of the outer dielectric proximate the distal end of the primary electrode, wherein the method comprises the steps of:
applying a voltage differential between the primary and secondary electrodes; and
generating the weakly ionized gas.

15. The method in accordance with claim 14, further comprising the step of introducing a first reagent gas into the capillary.

16. The method in accordance with claim 14, further comprising the step of introducing a first reagent gas into the discharge zone.

17. The method in accordance with claim 16, further comprising the step of introducing a second reagent gas into the discharge zone.

18. The method in accordance with claim 17, wherein the first and second reagent gases are the same.

19. The method in accordance with claim 17, wherein the first and second reagent gases are different.

20. The method in accordance with claim 14, further comprising the step of varying the depth of insertion of the primary electrode axially in the capillary of the inner dielectric.

21. The method in accordance with claim 20, wherein a distal end of the primary electrode is partially inserted into the inner dielectric so as to be recessed by a predetermined distance from a distal end of the inner dielectric.

22. The method in accordance with claim 21, wherein the predetermined distance separation between the distal end of the primary electrode and the distal end of the inner dielectric is approximately 2 mm.

23. The method in accordance with claim 14, further comprising the step of placing an object to be treated proximate the distal end of the generator from which the weakly ionized gas is emitted.

24. The method in accordance with claim 14, further comprising the step of introducing an object to be treated into the capillary.

25. The method in accordance with claim 14, wherein the inner and outer dielectrics are substantially concentric.

26. The method in accordance with claim 14, wherein the emission is a weakly ionized gas plume substantially equal in size to an inner opening of the outer dielectric.

27. The method in accordance with claim 14, wherein the secondary electrode is at least partially enclosed in a barrier dielectric to suppress arcing between the outer dielectric and the secondary electrode.

28. The method in accordance with claim 14, wherein the secondary electrode lies in a plane that is disposed substantially perpendicular to a longitudinal axis of the primary electrode.
